(19) United States
(12) Patent Application Publication
(10) Pub. No.: US 2005/0121900 A1
(43) Pub. Date: Jun. 9, 2005

(54) Method of producing a holographic image

(76) Inventor: Joey Hoo Yin Kwok, Hong Kong (HK)

Correspondence Address: Yukiko Iwata;Shell Oil Company, Legal - Intellectual Property, P.O. Box 2463, Houston, TX, 77252-2463, US

(21) Appl. No.: 10/994,616

(22) Filed: Nov. 22, 2004

Related U.S. Application Data
(60) Provisional application No. 60/527,408, filed on Dec. 5, 2003.

(51) Int. Cl. G01D 11/00; B42D 15/00

(52) U.S. Cl. 283/114

(57) ABSTRACT

Disclosed herein is a method for producing a holographic image. The method includes engraving an image onto an engraved roller, applying colorant to the engraved roller, and embedding the image onto a print medium. The method further considers embossing the embedded image with a holographic embossing roller to transform the image into a holographic image then applying a protective coating to the outer surface of the holographic image.

This application claims the benefit of U.S. Provisional Application No. 60/527,408 filed Dec. 5, 2003, the entire disclosure of which is hereby incorporated by reference.

### BACKGROUND OF THE INVENTION

1. Field of the Invention

The invention relates generally to the field of forming images onto a print medium. More specifically the present invention deals with an apparatus used to form images onto a print medium. Yet more specifically, the present invention concerns a composition bearing an image. Yet even more specifically, the present invention deals with a novel method of embedding an image onto a print medium and embossing the image to produce a holographic image.

2. Description of Related Art

Holographic images cast the illusion of a three-dimensional object and can be produced by the interaction of lasers or from an embossed hologram. The holographic image produced by an embossed hologram reflects light in a way to create the illusion of a three-dimensional object. Embossed holograms are made pressing a holographic image from a master print into a substrate that can be plastic, paper, polymer, film, or some other image bearing substance. The master is typically formed onto a metal plate that is subsequently pressed into the substrate with heat and pressure.

Embossed holograms can be produced in the full spectrum of colors and can even be tuned to display actual colors. Embossed holograms also may be entirely reflective when proper light is not provided or when viewed at some oblique angle. This results in the embossed hologram being noticeable and recognizable all of the time. These holograms can be produced to represent full motion, i.e. as though a video or movie is being viewed. Recently, embossed holograms have been utilized in a security setting, such as in use with credit cards, software, CD's, tickets and the like. Further, embossed holograms are a being widely used in designs notable for aesthetic and eye pleasing qualities when viewed in a holographic aspect.

Generally, the holographic image is embossed onto a substrate by applying a colorant to the surface of the substrate, then embossing the substrate with the master print. Typically the master print is in the form of a shim that is mounted on the outer surface of a heated roller. As the master print embosses the substrate covered with colorant, a holographic image is imprinted onto the substrate. One of the problems associated with this technique is that not all of the colorant applied to the substrate is required in order to form the holographic image on the substrate. This results in wasted colorant as well as the added steps of removing or cleaning the unused or un-required colorant. Further, in some instances a reactive lacquer is used to enhance or fine-tune the holographic image. Depending on the type of lacquer used, it can react with the colorant, thus possibly altering the final look of the image. Thus a need exists for a method of producing holographic images that optimizes the application of colorant and ensures that the holographic image produced is the holographic image desired.

### BRIEF SUMMARY OF THE INVENTION

The present invention involves a method of producing a image comprising applying a colorant to the outer surface of an engraved roller. A contoured surface is provided on the outer circumference of the engraved roller and application of the colorant to the engraved roller is substantially limited in application to the contoured surface. The method also comprises engaging the outer circumference of the engraved roller against a print medium. Engaging the print medium deposits the colorant applied to the outer circumference of the engraved roller onto the surface of the print medium. The method further comprises passing the print medium across a holographic embossing roller to produce a holographic image onto the print medium. The method also includes providing a plating protective covering to cover the holographic. The image can be applied to sunscreens, signs, wrapping paper, or any other surface on which a design is desired.

In one embodiment of the invention, the colorant of the method disclosed herein is comprised of a mixture of polyurethane resin, organic dye, and organic solvent. More preferably the mixture is comprised of about 20% by weight of polyurethane resin, about 3-15% by weight of organic dye, and about 65-77% by weight of organic solvent.

The print medium can be paper, film, thermoplastics, including polyolefin, polyolefin terephtalates, polyethylene, or any other medium capable of having an image embossed upon its surface. Where the print medium is comprised of polyethylene terephthalate, it can comprise a film side surface tension of 55 dyne/cm and a film thickness of from 15 to 23 microns. The method can further comprise heating the print medium to a temperature range in the range of from about 100° C. to about 200° C, more preferably the method can comprise heating the print medium to about 150° C. The protective plating of the method disclosed herein can comprise vacuum metallized aluminum. The protective plating can have a thickness of about 450 angstroms.

Also considered within the present invention is an apparatus to form an image onto a print medium. This apparatus comprises an engraved roller having a contoured surface engraved on its outer circumference forming an image and a colorant application device that applies colorant to the contoured surface. When the engraved roller transfers the colorant to a print medium it thereby substantially forms the image on the outer circumference of the engraved roller onto the print medium. The apparatus can further comprise a nip roller in combination with the engraved roller to provide a reactive force for transferring the colorant to the print medium. The apparatus further comprises a holographic embossing roller to emboss a holographic image onto the print medium.

The present invention can also include an image bearing composition comprising a print medium and a colorant applied to the print medium. The colorant is transferred to the print medium by an engraved roller having a contoured surface, where the colorant is applied to the outer circumference of the engraved roller. The image bearing composition can further comprise a holographic image formed thereon by a holographic embossing roller. A protective plating can also be included with the image bearing composition. The print medium of the image bearing composition can be any medium capable of having an image embossed upon its surface.

The present invention therefore provides as one of its many advantages the ability to transfer a pattern of colorant in the form of an image onto a print medium by applying the colorant to the outer circumference of an engraved roller prior to transferring the colorant to the print medium. Accordingly the step of applying colorant directly to the print medium by another means can be eliminated.

### BRIEF DESCRIPTION OF THE SEVERAL VIEWS OF THE DRAWINGS

FIG. 1A depicts a cross sectional view of the method of one embodiment of the present invention.

FIG. 1B depicts a cross sectional view of the method of one embodiment of the present invention.

FIG. 2 illustrates a cross sectional view of the final product formed by one embodiment of the present invention.

FIG. 3A portrays a cross section partial view of alternative embodiments of an engraved roller.

FIG. 3B portrays a cross section partial view of alternative embodiments of an engraved roller.

FIG. 4 depicts a cross sectional view of one embodiment of the present invention.

### DETAILED DESCRIPTION OF THE INVENTION

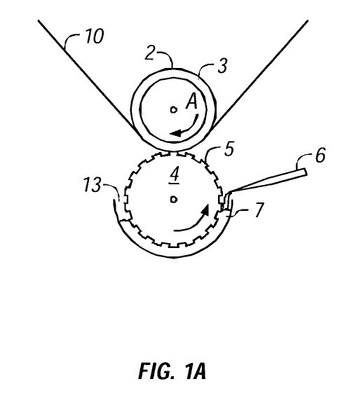

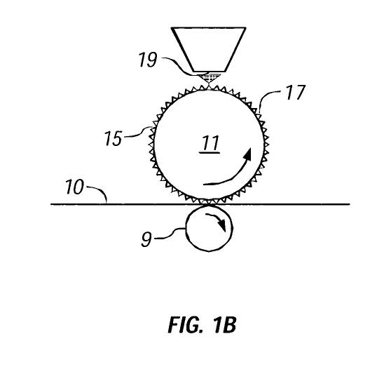

The method described herein is useful to form images onto a print medium. Furthermore, the image can be further processed to be a holographic image. The image can be two-dimensional or three-dimensional. With reference to the drawing herein, a cross sectional of one embodiment of the image forming process of the present invention is illustrated in FIGS. 1A and 1B. A print medium 10 is passed between an impression roller 2 and a printed gravure roller 4 (also known as an engraved roller). More specifically, the impression roller 2 includes a pliable outer surface 3, preferably comprised of a polymeric or rubber material. Disposed on the outer circumference of the printed gravure roller 4 is a raised portion 5 having a contoured surface. The raised portion 5 projects outward from the printed gravure roller 4 such that the raised portion 5 comprises a type of design. As the print medium 10 is squeezed between the printed gravure roller 4 and the impression roller 2, the pattern formed by the raised portion is impinged onto the print medium 10.

The design formed onto the raised portion 5 can be any recognizable design, such as landscape, flame pattern, or can also be a fanciful, abstract, or some design not related to any other known image or object. The design formed by the method described herein may be any design desired to be embossed. The raised portion 5 can be formed onto the printed gravure roller 4 in any now or later developed process, however the preferred method is that a computerized engraving system engrave the desired pattern. Further, should the desired pattern be two-dimensional, this can be accomplished by maintaining a substantially even depth of engraving onto the gravure roller 4. In contrast, should the desired pattern be three-dimensional, the engraving depth can be varied in order to achieve a three-dimensional aspect to the final design. It is believed that developing a two-dimensional or a three-dimensional contoured surface is can be accomplished by those skilled can in the art without undue experimentation.

A colorant 7 is applied to the raised portion 5 of the printed gravure roller 4. The colorant 7 should be applied to the printed gravure roller 4 before the it engages the print medium 10 since the colorant 7 is transferred to the print medium 10 by the raised portion 5 of the printed gravure roller 4. The colorant 7 can be imbedded within the surface of the print medium 10 or applied on top of the surface of the print medium 10 by the printed gravure roller 4. Also, the colorant 7 should be continuously and consistently applied to the printed gravure roller 4 as the print medium 10 is being processed by the printed gravure roller 4 and the impression roller 2.

The colorant 7 can be any coloring agent suitable to embed a pattern or image onto a print medium and will generally be selected for its suitability with a particular print medium. For example, for use with PET, the preferred colorant is comprised of a resin coating mixture. The preferred composition of the mixture for use with PET is about 20% by weight of a polyurethane resin, a dye, and a solvent. The amount of dye depends on the desired look and appearance of the final image as well as the print medium considered. Accordingly the dye percentage considered for use with PET can vary from about 3%-15% by weight of the resin coating mixture, thus the solvent can comprise from about 65% to about 77% by weight of the resin coating mixture. As is well known, increasing the percentage of the dye to the resin coating mixture results in a deeper color applied to the design. Optionally the colorant 7 can be comprised of direct dyes, acidic dyes, basic dyes, mordant dyes, vat dyes, sulfide dyes, soluble vat dyes, azoic dyes, reactive dyes, cationic dyes, disperse dyes, oxidizing dyes, metal complex dyes, and any other now or later developed coloring agent. It is believed that it is within the capabilities of those skilled in the art to develop the type, composition, and component percentages of the colorant.

The preferred manner of applying colorant 7 to the printed gravure roller 4 is shown in FIG. 1A. As shown, the colorant 7 is applied to the printed gravure roller 4 by maintaining a level of colorant 7 within a reservoir 13. As the printed gravure roller 4 rotates within the reservoir 13, the colorant 7 adheres to the outer surface of the raised portion 5 of the printed gravure roller 4. Further, due to the viscosity of the colorant 7, substantially all of the colorant 7 that adheres to the raised portion 5 from the reservoir 13 will remain on the raised portion 5 until it contacts the print medium 10. However the present invention includes other colorant application devices that can apply the colorant 7 to the printed gravure roller 4, such as a brush, a spray, a wick, or any other known or later developed technique. The level of colorant 7 applied to the printed gravure roller 4 should be monitored however to ensure the proper amount of colorant 7 is embedded onto the printed medium 10. If too much colorant 7 is applied bleeding or smudging may occur, whereas if insufficient colorant 7 is supplied, the desired image may not be formed onto the printed medium 10. It is therefore preferred that the application of the colorant 7 be limited to the raised portion 5 of the printed gravure roller 4. A blade 6 is included to scrape off and remove excessive colorant 7 from the outer surface of the raised portion 5. The selection and implementation of a proper blade 6 to prevent excessive colorant 7 from remaining on the raised portion can be accomplished by those skilled in the art.

When the print medium 10 passes between the impression roller 2 and the printed gravure roller 4, the image of the raised portion 5 is then transferred onto the print medium 10, thereby producing a resin coated image onto the printed medium 10. The image transfer occurs not only by the “embossing” effect of the raised portion 5 onto the print medium 10, but also because of the colorant 7 that is embedded onto the print medium 10. As such, the force imparted onto the print medium 10 by the impression roller 2 should be sufficient to produce the embedding function of the printed gravure roller 4 without otherwise damaging the print medium 10.

The print medium 10 can be selected from the group consisting of paper, film, thermoplastics, including polyolefin, polyolefin terephtalates, polyethylene, or any other medium capable of having an image embossed upon its surface.

To ensure proper embedding of the colorant 7 onto the print medium 10, especially when the print medium considered is PET, the temperature of the colorant 7 and print medium 10 should be maintained at a temperature in a range of about 100° C. to about 200° C., more preferably, the temperature of the colorant 7 and the print medium 10, should be maintained at a temperature of about 150° C. Further, the speed at which the print medium 10 passes through the printed gravure roller 4 and the impression roller 2 should be maintained constant, preferably at a rate of about 80 m/min.

After the coloration step is complete, the print medium 10 passes from the printed gravure roller 4, and travels in the direction of the arrow A for holographic embossing. The holographic embossing roller 11 works in conjunction with a nip roller 9 to press the print medium 10 between these two rollers. Optionally disposed on the outer surface 15 of the holographic embossing roller 11 is an embossing surface 17. As is well known, squeezing the print medium 10 (having the embedded image formed by the printed gravure roller 4) between the embossing surface 17 and the nip roller 9 transforms the image embedded on the print medium 10 into a holographic image. Optionally, a reactive compound 19, such as lacquer, can be applied to the surface of the holographic embossing roller 11 to react with the resin coated mixture on the printed medium 10. The holographic embossing roller 11 contours the surface of the print medium 10 as it rolls over the print medium 10, and the reactive compound 19 reacts with the colorant 7 embedded within the print medium 10. The combination of the embossing effect of the holographic embossing roller 11 in combination with the reactive compound 19 is to transform the resin coated image on the print medium 10 into a holographic image. One of the many advantages of the present invention is that the reaction between the reactive compound 19 and the colorant 7 within the print medium 10 is restricted to only where the image is present on the print medium 10. Other prior art techniques involve applying the colorant 7 to the entire surface of the print medium 10 which would result in an undesirable final image unless the unused colorant 7 were first removed. Thus implementation of the present invention optimizes the use of the colorant 7 by reducing waste as well as reducing the number of steps required in the holographic process.

In a non-limiting example the print medium 10 can be comprised of corona treated polyethylene terephthalate (PET) with a film side surface tension of about 55 dyne/cm and a variant film thickness of from about 15 to about 23 microns. The print medium 10 can also be comprised of paper, film, thermoplastics, including polyolefin, polyolefin terephtalates, polyethylene, or any other medium capable of having an image embossed upon its surface.

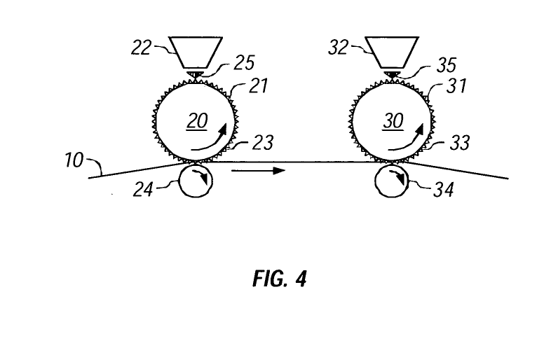

An alternative embodiment of the present invention for embossing a holographic image onto a print medium is illustrated in FIG. 4. This alternative embodiment comprises an engraved roller 20 with an outer circumferential surface 21. Formed on the outer circumferential surface 21 of the engraved roller 20 is a contoured surface 23 that extends outward from the outer circumferential surface 21. It is preferred that the contoured surface 23 be configured to form a pattern or design. The design can be any recognizable design, such as landscape, flame pattern, or can also be a fanciful, abstract, or some design not related to any other known image or object. The design formed by the method described herein may be any design to be embossed onto a surface. The contoured surface 23 can be formed onto the engraved roller 20 in any now or later developed process, however the preferred method is that a computerized engraving system engrave the desired pattern onto the outer circumferential surface 21 of the engraved roller 20. Further, should the desired pattern be two-dimensional, this can be accomplished by maintaining a substantially even depth of engraving onto the engraved roller 20. In contrast, should the desired pattern be three-dimensional, the engraving depth can be varied in order to achieve a three-dimensional aspect to the final design. It is believed that developing a two-dimensional or a three-dimensional contoured surface is can be accomplished by those skilled can in the art without undue experimentation.

A colorant 25 is applied to the outer circumferential surface 21 of the engraved roller 20. The colorant 25 should be applied to the engraved roller 20 before the engraved roller 20 engages the print medium 10 since the colorant 25 is transferred to the print medium 10 by the contoured surface 23 of the engraved roller 20. The colorant 25 can be imbedded within the surface of the print medium 10 or applied on top of the surface of the print medium 10 by the engraved roller. Also, the colorant 25 should be continuously and consistently applied to the engraved roller 20 while the print medium 10 is processed by the engraved roller 20.

The colorant 25 can be any coloring agent suitable to embed a pattern or image onto a print medium and will generally be selected for its suitability with a particular print medium. For example, for use with PET, the preferred colorant is comprised of a resin coating mixture. The preferred composition of the mixture for use with PET is about 20% by weight of a polyurethane resin, a dye, and a solvent. The amount of dye depends on the desired look and appearance of the final image as well as the print medium considered. Accordingly the dye percentage considered for use with PET can vary from about 3% to about 15% by weight of the resin coating mixture, thus the solvent can comprise from about 65% to about 77% by weight of the resin coating mixture. As is well known, increasing the percentage of the dye to the resin coating mixture results in a deeper color applied to the design. Optionally the colorant 25 can be comprised of direct dyes, acidic dyes, basic dyes, mordant dyes, vat dyes, sulfide dyes, soluble vat dyes, azoic dyes, reactive dyes, cationic dyes, disperse dyes, oxidizing dyes, metal complex dyes, and any other now or later developed coloring agent. It is believed that it is within the capabilities of those skilled in the art to develop the type, composition, and component percentages of the colorant.

As shown the colorant 25 is applied to the engraved roller 20 via a colorant application device, such as a coloring hopper 22. Here the colorant 25 flows from the coloring hopper 22 onto the surface of the contoured surface 23. However the present invention includes other colorant application devices that can apply the colorant 25 to the engraved roller 20, such as a brush, a spray, a wick, or any other known or later developed technique. The level of colorant 25 applied to the engraved roller 20 should be monitored however to ensure the proper amount of colorant 25 is embedded onto the printed medium 10. If too much colorant 25 is applied bleeding or smudging may occur, whereas if insufficient colorant 25 is supplied, the desired image may not be formed onto the printed medium 10. It is therefore preferred that the application of the colorant 25 be limited to the contoured surface 23 of the engraved roller 20.

When the print medium 10 passes between the nip roller 24 and the engraved roller 20, the image of the contoured surface 23 is then transferred onto the print medium 10, thereby producing a resin coated image onto the printed medium 10. The image transfer occurs not only by the “embossing” effect of the contoured surface 23 onto the print medium 10, but also because of the colorant 25 that is embedded onto the print medium 10. As such, the force imparted onto the print medium 10 by the nip roller 24 should be sufficient to produce the embedding function of the engraved roller 20 without otherwise damaging the print medium 10.

To ensure proper embedding of the colorant 25 onto the print medium 10, especially when the print medium considered is PET, the temperature of the colorant 25 and print medium 10 should be maintained at a temperature in the range of about 100° C. to about 200° C., more preferably, the temperature of the colorant 25 and the print medium 10, should be maintained at a temperature of about 150° C. Further, the speed at which the print medium 10 passes through the nip roller 24 and engraved roller 20 should be maintained constant, preferably at a rate of about 80 m/min.

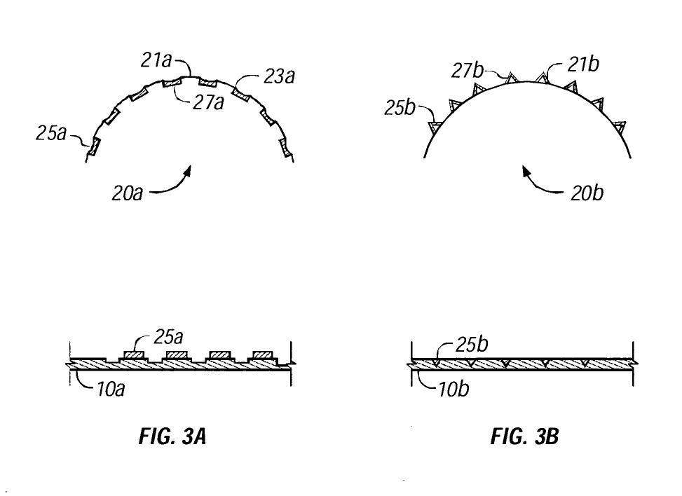

In FIGS. 3A and 3B alternative embodiments for the engraved roller, 20a and 20b respectively, are illustrated. In the case of the engraved roller 20a, the contoured surface 23a is comprised of a series of indentations 27a pressed into the outer circumferential surface 21a of the engraved roller 20a. The indentations while shown as generally rectangular, can be of any shape as long as the desired image is pressed into the outer circumferential surface 21a of the engraved roller 20a. In this alternative embodiment colorant 25a is pooled within the indentations 27a as it is applied to the engraved roller 20a. As the portions of the engraved roller 20a containing the pooled colorant 25a are meshed with the print medium 10, the colorant 25a within the indentations 27a is deposited on the print medium 10 thereby forming the image engraved on the engraved roller 20a onto the print medium 10. In contrast, the alternative embodiment of the engraved roller 20b has a series of raised portions 27b representing the desired image are engraved on the outer surface 21b of the engraved roller 20b. In this embodiment the colorant 25b is applied onto the raised portions 27b. Here the colorant 25b is embedded beneath the outer surface of the print medium 10b as the engraved roller 20b engages the print medium 10b.

Upon completion of the coloration step, the print medium 10 passes from the engraved roller 20, and travels in the direction of the arrow towards the holographic embossing roller 30. As with the engraved roller 20, the holographic embossing roller 30 can work in conjunction with a nip roller 34 to press the print medium 10 between these two rollers. Optionally disposed on the outer surface 31 of the holographic embossing roller 30 is an embossing surface 33. As is well known, squeezing the print medium 10 (having the embedded image formed by the engraved roller 20) between the embossing surface 33 and the nip roller 34 transforms the image embedded on the print medium 10 into a holographic image. Optionally, a reactive compound 35, such as lacquer, can be applied to the surface of the holographic embossing roller 30 to react with the resin coated mixture on the printed medium 10. While the lacquer 35 can be applied through a lacquer hopper 32 onto the holographic embossing roller 30, other methods and techniques exist, such as sprays, wicks, vats, and any other now known or later developed lacquer application manner. The holographic embossing roller 30 contours the surface of the print medium 10 as it rolls over the print medium 10, and the reactive compound 35 reacts with the colorant 25 embedded within the print medium 10. The combination of the embossing effect of the holographic embossing roller 30 in combination with the reactive compound 35 is to transform the resin coated image on the print medium 10 into a holographic image. One of the many advantages of the present invention is that the reaction between the reactive compound 35 and the colorant 25 within the print medium 10 is restricted to only where the image is present on the print medium 10. Other prior art techniques involve applying the colorant 25 to the entire surface of the print medium 10 which would result in an undesirable final image unless the unused colorant 25 were first removed. Thus implementation of the present invention optimizes the use of the colorant 25 by reducing waste as well as reducing the number of steps required in the holographic process.

After the desired holographic image has been produced on the surface of the print medium 10, a protective covering 18 can be applied to the surface. As one non-limiting example, a protective covering is an electroplated vacuum metallized aluminum surface with a thickness of about 450 angstroms. However many other coverings may be applied, such as stainless steel, nichrome, gold, silver, platinum or any other metal which can be vaporized and deposited by vacuum deposition or applied by sputtering or electron beam deposition. The protective covering may be applied by vacuum metal deposition, sputtering, electron beam deposition, or any other now known or later developed method of applying such a protective covering. Optionally, the protective covering can be added to the print medium 10 without having added a holographic image to the print medium 10, thus resulting in a silver colored reflective surface.

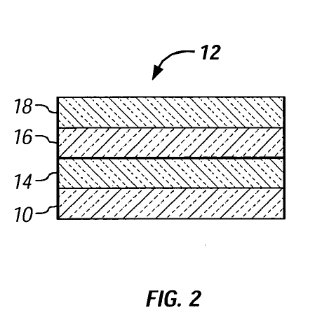

A cross sectional view illustrating a reflective hologram 12 is depicted in FIG. 2. The reflective hologram 12 comprises the resin coating mixture 14 adhered to the print medium 10 on top of which the holographic layer 16 is disposed. The reflective hologram 12 can be produced by any of the holographic producing processes described herein. Covering the holographic layer 16 is the protective covering 18. The dimensions of the reflective hologram 12 will be dictated by its proposed application. For example, holograms have a wide usage in the credit card industry, thus in this application the dimensions would be less than a few squared centimeters. Conversely, holographic images can be used for signs, sunscreens, wrapping paper, and other large coverings. In these instances the overall size of the holographic image could exceed many square meters. Accordingly, the scope of the present invention is not limited to a specific size or application, but includes holographic images of any dimension as well as application.

The present invention described herein, therefore, is well adapted to carry out the objectives and attain the ends and advantages mentioned, as well as others inherent therein. While a presently preferred embodiment of the invention has been given for purposes of disclosure, numerous changes exist in the details of procedures for accomplishing the desired results. Such as, adjusting the thickness of the protective layer to be less than 450 angstroms, more specifically in the range of from about 200 to about 350 angstroms, thereby affecting the transmissibility of the holographic image through the protective layer. These and other similar modifications will readily suggest themselves to those skilled in the art, and are intended to be encompassed within the spirit of the present invention disclosed herein and the scope of the appended claims.

1. A method of producing an image comprising:
applying a colorant to the outer surface of an engraved roller, wherein a contoured surface is provided on the outer circumference of the engraved roller, wherein the application of the colorant to the engraved roller is substantially limited in application to the contoured surface; and
engaging the outer circumference of the engraved roller against a print medium, thereby depositing the colorant applied to the outer circumference of the engraved roller onto the surface of the print medium.

2. The method of claim 1 further comprising passing the print medium across a holographic embossing roller, thereby producing a holographic image onto the print medium.

3. The method of claim 1 further comprising providing a plating protective covering to the print medium covering the holographic image.

4. The method of claim 1 wherein the colorant is comprised of a mixture of polyurethane resin, organic dye, and organic solvent.

5. The method of claim 4 wherein the mixture is comprised of about 20% by weight of polyurethane resin, for about 3 to about 15% by weight of organic dye, and from about 65 to about 77% by weight of organic solvent.

6. The method of claim 1 wherein the print medium is any medium capable of having an image embossed upon its surface.

7. The method of claim 1 further comprising heating the print medium to a temperature in the range of from about 100° C. to about 200° C.

8. The method of claim 1 further comprising heating the print medium to a temperature of about 150° C.

9. The method of claim 1 wherein the protective plating comprises vacuum metallized aluminum.

10. The method of claim 9 wherein the protective plating is a thickness of about 450 angstroms.

11. The method of claim 1 further comprising applying the print medium with a holographic image to a sunscreen.

12. The method of claim 1 wherein the print medium is comprised of corona treated polyethylene terephthalate, having a film side surface tension of about 55 dyne/cm and a film thickness of from about 15 to about 23 microns.

13. The method of claim 6 wherein the prior medium is selected from the group consisting of paper, film, thermoplastics, including polyolefin, polyolefin terephtalates, polyethylene.

14. An apparatus to form an image onto a print medium comprising;
an engraved roller having a contoured surface engraved on its outer circumference forming an image; and
a colorant application device that applies colorant to said contoured surface, where the engraved roller transfers the colorant to a print medium thereby substantially forming the image on the outer circumference of the engraved roller onto the print medium.

15. The apparatus of claim 14 further comprising an impression roller in combination with said engraved roller to provide a reactive force for transferring the colorant to the print medium.

16. The apparatus of claim 14 further comprising a holographic embossing roller to emboss a holographic image onto the print medium.

17. An image bearing composition comprising:
a print medium; and
a colorant applied to the print medium, where the colorant is transferred to the print medium by an engraved roller having a contoured surface, where the colorant is applied to the outer circumference of the engraved roller.

18. The image bearing composition of claim 17 further comprising a holographic image formed thereon by a holographic embossing roller.

19. The image bearing composition of claim 17 further comprising a protective plating formed thereon.

20. The image bearing composition of claim 17 wherein the print medium is any medium capable of having an image embossed upon its surface.

21. The image bearing composition of claim 20 wherein the print medium is selected from the group consisting of paper, film, thermoplastics, including polyolefin, polyolefin terephtalates, polyethylene.
